(19) United States
(12) Patent Application Publication
(10) Pub. No.: US 2007/0030466 A1
(43) Pub. Date: Feb. 8, 2007

(54) Exposure apparatus control method, exposure method and apparatus using the control method, and device manufacturing method

(75) Inventor: Matsunari Shuichi, Sagamihara-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: NIKON CORPORATION

(21) Appl. No.: 11/542,195

(22) Filed: Oct. 4, 2006

Related U.S. Application Data
(63) Continuation of application No. PCT/JP05/14512, filed on Aug. 8, 2005.
(60) Provisional application No. 60/723,911, filed on Oct. 6, 2005.

(30) Foreign Application Priority Data
Aug. 9, 2004 (JP) 2004-232086

(51) Int. Cl. G03B 27/52

(52) U.S. Cl. 355/30; 355/53

(57) ABSTRACT

An exposure apparatus control method maintains good characteristics of optical elements for a long period of time. The partial pressure of a deterioration causing gas, which is an oxidizing gas or a coating forming gas, is monitored by a mass spectrometry apparatus. A deterioration suppressing gas from a gas supply apparatus is appropriately introduced into a vacuum container. In addition, decreases in the reflectivity of optical elements are monitored by a luminous flux intensity sensor, and a deterioration suppressing gas is appropriately introduced into the vacuum container.

### CROSS REFERENCE TO RELATED APPLICATIONS

This U.S. patent application claims priority to U.S. provisional patent application No. 60/723,911, filed on Oct. 6, 2005, the contents of which are incorporated herein by reference. This application is a continuation of International Application No. PCT/JP 2005/014512, filed on Aug. 8, 2005, the contents of which are incorporated herein by reference.

### BACKGROUND

1. Technical Field

The present invention relates to an exposure apparatus control method that forms a mask pattern image on a substrate, an exposure method and apparatus using the control method, and a device manufacturing method that uses an ultraviolet or extreme ultraviolet exposure apparatus.

2. Background Art

In conjunction with the miniaturization of semiconductor integrated circuits and due to the diffraction limits of light, exposure technology that uses ultraviolet rays has been developed to improve resolution of optical systems. In addition, exposure technology that uses, instead of ultraviolet rays, extreme ultraviolet rays of a shorter wavelength (for example, 11˜14 nm) is also being developed (see Japanese Unexamined Patent Application Publication No. 2003-14893).

### SUMMARY OF THE INVENTION

An exposure apparatus control method includes the steps of monitoring an observation element that reflects at least one of causes and indications of deterioration of an optical system of an exposure apparatus and introducing into a container a deterioration suppressing gas that includes at least one of a reducing gas, an oxidizing gas, and a fluorinating gas according to the monitoring results.

A first example that embodies the exposure apparatus control method comprises a process that monitors the partial pressure of a deterioration causing gas that includes at least one of oxygen, water, and an organic substance in a container that accommodates an optical system of an exposure apparatus and a process that introduces a deterioration suppressing gas into a container according to the monitoring results of the deterioration causing gas so that the partial pressure of a deterioration suppressing gas that includes at least one of a reducing gas, an oxidizing gas, and a fluorinating gas has a ratio in a prescribed range with respect to the partial pressure of the deterioration causing gas in the container.

A second example that embodies the exposure apparatus control method comprises a process that monitors the spectral characteristics of at least one optical element that comprises the optical system of an exposure apparatus and a process that introduces a deterioration suppressing gas that includes at least one of a reducing gas, an oxidizing gas, and a fluorinating gas into a container that accommodates at least one optical element according to the results of monitoring of the spectral characteristics of at least one optical element.

A first exposure method forms a mask pattern image on a substrate and comprises a process for monitoring the partial pressure of a deterioration causing gas that includes at least one of oxygen, water, and an organic substance in a container that accommodates an optical system for exposure and a process that introduces a deterioration suppressing gas into the container according to the monitoring results of the deterioration causing gas so that the partial pressure of the deterioration suppressing gas that includes at least one of a reducing gas, an oxidizing gas, and a fluorinating gas comes to have a ratio in a prescribed range with respect to the partial pressure of the deterioration causing gas in the container.

A second exposure method forms a mask pattern image on a substrate and comprises a process that monitors the spectral characteristics of at least one optical element that comprises an optical system for exposure and a process that introduces a deterioration suppressing gas that includes at least one of a reducing gas, an oxidizing gas, and a fluorinating gas into a container that accommodates at least one optical element according to the monitoring results of the spectral characteristics of at least one optical element.

A first exposure apparatus comprises a light source that generates light source light in a wavelength range of at least one of ultraviolet rays and extreme ultraviolet rays, an illumination optical system that guides light source light from the light source to a mask for transfer, a projection optical system that forms the pattern image of a mask on a substrate, a sensor that monitors the partial pressure of a deterioration causing gas that includes at least one of oxygen, water, and an organic substance in a container that accommodates at least some optical elements from among a mask, an illumination optical system, and a projection optical system, a gas introduction apparatus that introduces a deterioration suppressing gas that includes at least one of a reducing gas, an oxidizing gas, and a fluorinating gas into a container, and a control apparatus that sets the partial pressure of the deterioration suppressing gas to a ratio of a prescribed range with respect to the partial pressure of the deterioration causing gas in the container.

A second exposure apparatus comprises a light source that generates light source light in a wavelength range of at least one of ultraviolet rays and extreme ultraviolet rays, an illumination optical system that guides light source light from the light source to a mask for transfer, a projection optical system that forms the pattern image of a mask on a substrate, a sensor that monitors the spectral characteristics of at least one optical element from among at least some optical elements that are accommodated in the container and that comprise a mask, an illumination optical system, and a projection optical system, a gas introduction apparatus that introduces a deterioration suppressing gas that includes at least one of a reducing gas, an oxidizing gas, and a fluorinating gas into a container, and a control apparatus that controls the operation of the gas introduction apparatus according to the monitoring results of the spectral characteristics of at least one optical element.

A device manufacturing method uses an exposure apparatus as already described.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments.

FIG. 1 is a block diagram of a projection exposure apparatus.

FIG. 2 is a flow chart of a semiconductor device manufacturing process.

### DETAILED DESCRIPTION

In an exposure apparatus, an optical system for illumination or projection may use, for example, ultraviolet rays or extreme ultraviolet rays. The environment where the relevant optical system is placed is preferably an inert gas atmosphere or a vacuum. However, it is not possible to completely eliminate oxygen, moisture content, organic substances, etc. from the vicinity of the optical elements that comprise the optical system.

Ultraviolet rays and extreme ultraviolet rays have a high energy. An oxidation reaction thus unfortunately occurs due to the oxygen, moisture content, and substances of the surfaces of the optical elements being irradiated by ultraviolet rays or extreme ultraviolet rays. In addition, due to organic substances and substances of the surfaces of the optical elements being irradiated by ultraviolet rays or extreme ultraviolet rays, optical chemical vapor deposition (optical CVD) occurs, and a carbon film is unfortunately formed on the surface of the optical elements. Due to these phenomena, the transmission characteristics and the reflection characteristics of the optical elements deteriorate, and problems such as the lifespan of the optical system becoming shorter occur.

To resolve the above issues, an exposure apparatus control method monitors an observation element that reflects at least one of causes and indications of deterioration relating to the optical system of the exposure apparatus and introduces into a container a deterioration suppressing gas that includes at least one of a reducing gas, an oxidizing gas and a fluorinating gas according to the monitoring results of the observation element.

In the above control method, a deterioration suppressing gas that includes at least one of a reducing gas, an oxidizing gas, and a fluorinating gas is introduced into the container according to the monitoring results of the observation element, so it is possible to use the deterioration suppressing gas to appropriately offset effects such as those of oxidation and carbon film growth of the surface of the optical element attributable to the presence of a deterioration causing gas such as oxygen. Therefore, it is possible to maintain good characteristics of optical elements and, in turn, an optical system for an exposure apparatus for a long period of time.

The first mode in which the above exposure apparatus control method has been embodied comprises a process that monitors the partial pressure of a deterioration causing gas that includes at least one of oxygen, water and an organic substance in a container that accommodates an optical system of an exposure apparatus and a process that introduces a deterioration suppressing gas into a container according to the monitoring results of the deterioration causing gas so that the partial pressure of a deterioration suppressing gas that includes at least one of a reducing gas, an oxidizing gas and a fluorinating gas comes to have a ratio in a prescribed range with respect to the partial pressure of the deterioration causing gas in the container.

In the above control method, a deterioration suppressing gas is introduced into the container according to the monitoring results of the deterioration causing gas so that the partial pressure of the deterioration suppressing gas comes to have a ratio in a prescribed range with respect to the partial pressure of the deterioration causing gas in the container, so the deterioration suppressing gas can be used to appropriately offset the effects of oxidation and carbon film growth of the surface of the optical element that are due to a deterioration causing gas. In this case, it is possible to limit the possibility of the action of the deterioration suppressing gas becoming excessive and inflicting reverse damage on the optical element by setting the partial pressure ratio of the deterioration causing gas and the deterioration suppressing gas to a prescribed range. Therefore, it is possible to maintain good characteristics of optical elements and, in turn, an optical system for an exposure apparatus for a long period of time.

In a specific mode, in the above control method, the deterioration causing gas is an oxidation deterioration gas that includes at least one of oxygen and water, and the deterioration suppressing gas is an oxidation inhibiting gas that includes at least one of a reducing gas and a fluorinating gas. In this case, in the presence of a high energy light beam, for example, it is possible to prevent the optical element from corroding from the surface due to an oxidation reaction, or it is possible to prevent an oxidation film that becomes a cause of deterioration of characteristics from forming on the surface of the optical element, and it is possible to maintain good transmission characteristics and reflection characteristics of optical elements for a long period of time.

In another mode, the ratio of a prescribed range relating to the oxidation inhibiting gases as the deterioration suppressing gases is from 1×10⁻⁷ to 1×10⁴. In this case, an upper limit ratio of 1×10⁴ for these oxidation inhibiting gases has been determined so that the bad effects resulting from the reducing gas or fluorinating gas atmosphere are suppressed while maintaining safe and reliable operation of the vacuum pump for exhaust, and a lower limit ratio of 1×10⁻⁷ for the oxidation inhibiting gases has been determined in consideration of ensuring the effects resulting from the oxidation inhibiting gases and of the lower limit of the sensitivity of the sensor for monitoring.

In yet another mode, the deterioration causing gas is a coating forming gas that includes an organic substance, and the deterioration suppressing gas is a coating removing gas that includes at least one of a reducing gas, an oxidizing gas and a fluorinating gas. In this case, in the presence of a high energy light beam, for example, it is possible to prevent a carbon film from being produced on the surface of the optical element and light absorption from occurring by means of optical CVD of the organic substance, and it is possible to maintain good transmission characteristics and reflection characteristics of the optical elements for a long period of time.

In yet another mode, the ratio of a prescribed range relating to the coating removing gases as the deterioration suppressing gases is from 1×10⁻² to 1×10⁸. In this case, an upper limit ratio of 1×10⁸ for these coating removing gases has been determined so that the bad effects resulting from the reducing gas, oxidizing gas or fluorinating gas atmosphere are suppressed while maintaining safe and reliable operation of the vacuum pump for exhaust, and a lower limit ratio of 1×10⁻² for the coating removing gases has been determined in consideration of ensuring the effects resulting from the coating removing gases and of the lower limit of the sensitivity of the sensor for monitoring.

The second mode that embodies the exposure apparatus control method comprises a process that monitors the spectral characteristics of at least one optical element that comprises the optical system of an exposure apparatus and a process that introduces a deterioration suppressing gas that includes at least one of a reducing gas, an oxidizing gas and a fluorinating gas into a container that accommodates at least one optical element according to the results of monitoring of the spectral characteristics of at least one optical element. Here, the “spectral characteristics” of the optical element refer to optical characteristics such as the transmission rate, the reflectivity, etc. of the optical element in the wavelength range of the exposure light.

In the above control method, a deterioration suppressing gas that includes at least one of a reducing gas, an oxidizing gas and a fluorinating gas is introduced according to the results of monitoring of the spectral characteristics of at least one optical element, so it is possible to use the deterioration suppressing gas to appropriately offset effects such as those of oxidation of the surface of the optical element attributable to the presence of a deterioration causing gas such as oxygen. Therefore, it is possible to maintain good characteristics of optical elements and, in turn, an optical system for an exposure apparatus for a long period of time.

In a specific mode, in the above control method, the optical system accommodated in the container is used in at least one wavelength range from among ultraviolet rays and extreme ultraviolet rays. In this case, an exposure environment results in which oxidation or carbon film generation are likely to occur on the surface of the optical element, but a deterioration suppressing gas is introduced at the appropriate timing in the manner discussed above, so, regardless of the relevant exposure environment, it is possible to maintain good characteristics of an exposure apparatus optical system for a long period of time.

A first exposure method forms a mask pattern image on a substrate and comprises a process for monitoring the partial pressure of a deterioration causing gas that includes at least one of oxygen, water and an organic substance in a container that accommodates an optical system for exposure and a process that introduces a deterioration suppressing gas into the container according to the monitoring results of the deterioration causing gas so that the partial pressure of the deterioration suppressing gas that includes at least one of a reducing gas, an oxidizing gas and a fluorinating gas comes to have a ratio in a prescribed range with respect to the partial pressure of the deterioration causing gas in the container. The timing of introducing the deterioration suppressing gas into the container may be set to within an interval of or during suspension of exposure processing or during exposure processing.

In the above exposure method, the deterioration suppressing gas is introduced into the container according to the monitoring results of the deterioration causing gas so that the partial pressure of the deterioration suppressing gas comes to have a ratio in a prescribed range with respect to the partial pressure of the deterioration causing gas, so the deterioration suppressing gas can be used to appropriately offset the effects of oxidation and carbon film growth of the surface of the optical element attributable to deterioration causing gas. Therefore, it is possible to maintain good characteristics of optical elements and, in turn, an optical system for an exposure apparatus for a long period of time.

A second exposure method forms a mask pattern image on a substrate and comprises a process that monitors the spectral characteristics of at least one optical element that comprises an optical system for exposure and a process that introduces a deterioration suppressing gas that includes at least one of a reducing gas, an oxidizing gas and a fluorinating gas into a container that accommodates at least one optical element according to the monitoring results of the spectral characteristics of at least one optical element.

In the above exposure method, a deterioration suppressing gas that includes at least one of a reducing gas, an oxidizing gas and a fluorinating gas is introduced according to the monitoring results of the spectral characteristics of at least one optical element, so it is possible to use the deterioration suppressing gas to appropriately offset effects such as those of oxidation of the surface of the optical element attributable to the presence of a deterioration causing gas such as oxygen. Therefore, it is possible to maintain good characteristics of optical elements and, in turn, an optical system for an exposure apparatus for a long period of time.

The first exposure apparatus relating to the invention comprises a light source that generates light source light in a wavelength range of at least one of ultraviolet rays and extreme ultraviolet rays, an illumination optical system that guides light source light from the light source to a mask for transfer, a projection optical system that forms the pattern image of a mask on a substrate, a sensor that monitors the partial pressure of a deterioration causing gas that includes at least one of oxygen, water and an organic substance in a container that accommodates at least some optical elements from among a mask, an illumination optical system, and a projection optical system, a gas introduction apparatus that introduces a deterioration suppressing gas that includes at least one of a reducing gas, an oxidizing gas and a fluorinating gas into a container, and a control apparatus that sets the partial pressure of the deterioration suppressing gas to a ratio of a prescribed range with respect to the partial pressure of the deterioration causing gas in the container.

In the above exposure apparatus, the control apparatus sets the partial pressure of the deterioration suppressing gas to a ratio of a prescribed range with respect to the partial pressure of the deterioration causing gas in the container by controlling the operation of the gas introduction apparatus according to the monitoring results of the deterioration causing gas, so it is possible to use the deterioration suppressing gas to appropriately suppress and offset the effects of oxidation and carbon film growth of the surface of the optical element that are due to the deterioration causing gas Therefore, it is possible to maintain good characteristics of optical elements and, in turn, performance of an exposure apparatus for a long period of time.

In a specific mode, in the above first exposure apparatus, the deterioration causing gas is an oxidation deterioration gas that includes at least one of oxygen and water, and the deterioration suppressing gas is an oxidation inhibiting gas that includes at least one of a reducing gas and a fluorinating gas.

In another mode, the deterioration causing gas is a coating forming gas that includes an organic substance, and the deterioration suppressing gas is a coating removing gas that includes at least one of a reducing gas, an oxidizing gas and a fluorinating gas.

The second exposure apparatus relating to the present invention comprises a light source that generates light source light in a wavelength range of at least one of ultraviolet rays and extreme ultraviolet rays, an illumination optical system that guides light source light from the light source to a mask for transfer, a projection optical system that forms the pattern image of a mask on a substrate, a sensor that monitors the spectral characteristics of at least one optical element from among at least some optical elements that are accommodated in the container and that comprise a mask, an illumination optical system, and a projection optical system, a gas introduction apparatus that introduces a deterioration suppressing gas that includes at least one of a reducing gas, an oxidizing gas and a fluorinating gas into a container, and a control apparatus that controls the operation of the gas introduction apparatus according to the monitoring results of the spectral characteristics of at least one optical element.

In the above exposure apparatus, the control apparatus controls the operation of the gas introduction apparatus according to the monitoring results of the spectral characteristics of at least one optical element, so it is possible to use the deterioration suppressing gas to appropriately offset effects such as those of oxidation of the surface of the optical element attributable to the presence of a deterioration causing gas such as oxygen. Therefore, it is possible to maintain good characteristics of optical elements and, in turn, an optical system for an exposure apparatus for a long period of time.

In addition, through the device manufacturing method of the present invention, it is possible to manufacture a high performance device by using the above exposure apparatus.

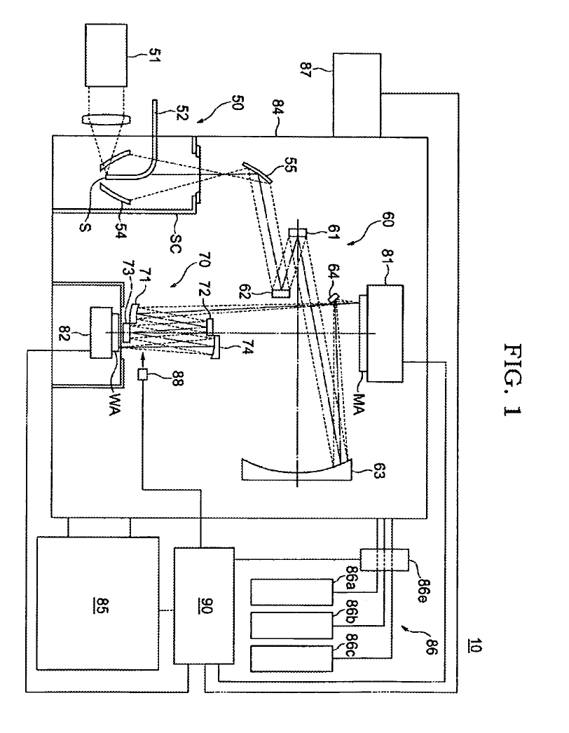

FIG. 1 shows a schematic structure of an exposure apparatus 10 according to an embodiment. In the exposure apparatus 10, a light source apparatus 50 generates extreme ultraviolet rays (wavelength 11˜14 nm). An illumination optical system 60 illuminates a mask MA by means of the illumination light of the extreme ultraviolet rays. A projection optical system 70 transfers the pattern image of the mask MA to a wafer WA that is the substrate. Referring to mechanical mechanisms, a mask stage 81 supports the mask MA, and a wafer stage 82 supports the wafer WA. A vacuum container 84 accommodates part of the light source apparatus 50 and the optical systems 60 and 70. An exhaust apparatus 85 exhausts gas in the vacuum container 84. A gas supply apparatus 86 introduces a deterioration suppressing gas into the vacuum container 84. A mass spectrometry apparatus 87 monitors the partial pressure of a specific gas in the vacuum container 84, and a luminous flux intensity sensor 88 checks decreases in the reflectivity of specific optical elements in the projection optical system 70.

In the exposure apparatus 10, a control apparatus 90 comprehensively controls the operations of the respective parts of the exposure apparatus 10, including the light source apparatus 50, the mask stage 81, the wafer stage 82, the exhaust apparatus 85, the gas supply apparatus 86, and the mass spectrometry apparatus 87.

In the light source apparatus 50, a laser light source 51 generates laser light for plasma excitation, and a tube 52 supplies gas such as xenon, which is the target material, into a housing SC. In addition, a condenser 54 and a collimator mirror 55 are attached to this light source apparatus 50. By focusing the laser light from the laser light source 51 on the xenon emitted from the front end of the tube 52, the target material of that portion is converted to a plasma to generate extreme ultraviolet rays. The condenser 54 focuses the extreme ultraviolet rays generated at the front end S of the tube 52. The extreme ultraviolet rays thus pass through the condenser 54, exit the housing SC while being converged, and are incident to the collimator mirror 55. It is possible to use, for example, irradiated light from a discharge plasma light source or an SOR (synchrocyclotron oscillation resonance) light source instead of light from a laser plasma type light source apparatus.

The illumination optical system 60 includes reflecting type optical integrators 61, 62, a condenser mirror 63, and a folding mirror 64. The condenser mirror 63 focuses light from the light source apparatus 50, while the optical integrators 61, 62 make the light uniform as illumination light. The folding mirror 64 directs the light to a prescribed region (for example, the strip-shaped region) on the mask MA. Through this, it is possible to evenly illuminate the specified region on the mask MA by means of extreme ultraviolet rays of the appropriate wavelength.

Typically, substances do not have appropriate transmission properties in the wavelength range of extreme ultraviolet rays, and a reflection type mask is typically used for the mask MA rather than a transmission type mask.

The projection optical system 70 is a reduction projection system comprising a plurality of mirrors 71, 72, 73, 74. The projection optical system 70 forms an image on a wafer WA that has been coated with a resist. The circuit pattern in the pattern image formed on the mask MA is thus transferred to the resist. In this case, the region to which a circuit pattern is projected once is a linear or arc-shaped slit region, and, for example, it is possible to transfer a rectangular circuit pattern formed on the mask MA to a rectangular region on the wafer WA without waste by means of scanning exposure that synchronously moves the mask MA and the wafer WA.

The mask stage 81, under the control of the control apparatus 90, may move the mask MA to the desired position while supporting the mask MA and while closely monitoring the position, velocity, etc. of the mask MA. In addition, the wafer stage 82, under the control of the control apparatus 90, may move the wafer WA to the desired position while supporting the wafer WA and while closely monitoring the position, velocity, etc. of the wafer WA.

The portion of the above optical apparatus 50 that is arranged on the optical path of the extreme ultraviolet rays, the illumination optical system 60, and the projection optical system 70 are arranged inside a vacuum container 84, and attenuation of the exposure light is prevented. Specifically, extreme ultraviolet rays are absorbed into the atmosphere and attenuated, but attenuation of extreme ultraviolet rays, that is, decreases in the brightness and decreases in the contrast of the transferred image, are prevented by maintaining the optical path of the extreme ultraviolet rays to a prescribed vacuum level (for example, 1.3×10⁻³ Pa or less) while shielding the entire apparatus from the exterior by means of the vacuum container 84.

The optical elements 54, 55, 61, 62, 63, 64, 71, 72, 73, and 74 and the mask MA arranged in the optical path of the extreme ultraviolet rays inside the vacuum container 84 have a reflecting film formed on a base material made of quartz glass, for example, which is the substrate. The reflecting film is a multilayer film of several layers to several hundred layers formed by, for example, alternately laminating thin film layers consisting of two or more substances whose refractive indices with respect to a vacuum differ onto a substrate. It is possible to use, for example, an Mo layer and a Si layer as the two or more types of thin film layers that comprise this multilayer film.

The exhaust apparatus 85 has a vacuum pump connected to a vacuum container 84, and the interior of the vacuum container 84 is maintained at the required vacuum level based on control from the control apparatus 90. A gas supply apparatus 86 has a gas source 86a for a reducing gas, a gas source 86b for an oxidizing gas, and a gas source 86c for a fluorinating gas. A mass flow controller 86e regulates the gas flow volume. The gas supply apparatus 86 supplies only the required amount of deterioration suppressing gas, which is reducing gas, oxidizing gas, or fluorinating gas to the inside of the vacuum container 84 at the appropriate timing via introduction pipes based on control from the control apparatus 90. Through this, it is possible to regulate the partial pressure of the reducing gas, oxidizing gas, or fluorinating gas inside the vacuum container 84 to a target volume. It is thus possible to suppress the oxidation of and carbon growth on the surfaces of optical elements 54, 55, 61, 62, 63, 64, 71, 72, 73, 74. The mass flow controller 86e may be replaced with a device in which a leak valve to which a drive apparatus such as a motor has been added is combined with a mass flow meter, a pressure regulator, etc.

A mass spectrometry apparatus 87 consists of, for example, a quadripolar mass spectrometer, and it functions as a partial pressure sensor for detecting, from the mass spectrum, the amount of molecules or atoms present in the vacuum container 84. The mass spectrometry apparatus 87 may detect the partial pressure of an oxidation deterioration gas, for example, oxygen or water, as the deterioration causing gas, and the measurement results of the partial pressure of such an oxidation deterioration gas are output to the control apparatus 90 continuously or at the appropriate timing. In addition, the mass spectrometry apparatus 87 may detect the partial pressure of the coating forming gas, such as an organic substance. The measurement results of the partial pressure of such a coating forming gas are also output to the control apparatus 90 continuously or at the appropriate timing. At the time of detection of the coating forming gas, such as an organic substance, exhaustive detection of all of the organic substances may not be practical. Thus, taking into consideration the capability of the mass spectrometry apparatus 87, a technique that substitutes the sum total of the mass numbers within a range of mass numbers of 45 or more and less than 200 is convenient. As an alternative, the quadripolar mass spectrometer may be replaced with a bipolar mass spectrometer, etc.

Here, if an oxidation deterioration gas such as oxygen, water, etc. is present as the atmospheric gas of optical elements 54, 55, 61, 62, 63, 64, 71, 72, 73, and 74, and extreme ultraviolet rays are incident to the optical elements 54, 55, 61, 62, 63, 64, 71, 72, 73, and 74, the multilayer film of the surface of the relevant optical element is gradually permeated due to an oxidation reaction, or an oxidation film is formed on the surface of the multilayer film. There is thus a danger of the reflectivity of the optical element decreasing over time. For this reason, the partial pressure of the oxidation deterioration gas is monitored based on the detection results of the mass spectrometry apparatus 87. When the partial pressure of the oxidation deterioration gas has exceeded a fixed upper limit, the mass flow controller 86e regulates the gas supply apparatus 86 to introduce an appropriate amount of deterioration suppressing gas (oxidation inhibiting gas) to the vacuum container 84 from the gas sources 86a and 86c.

One of the deterioration suppressing gases supplied from the gas source 86a is a reducing gas, and, for example, hydrogen or ethanol is preferably used. The other deterioration suppressing gas supplied from the gas source 86c is a fluorinating gas, and, for example, hydrogen fluoride, nitrogen fluoride, or carbon fluoride is preferable used.

The amount of deterioration suppressing gas introduced to the vacuum container 84 is at a level that is able to offset the effects of the oxidation deterioration gas based on the partial pressure of the oxidation deterioration gas and the reduction capability of the deterioration suppressing gas. For example, in the case where it is possible to return the partial pressure of the oxidation deterioration gas to the maximum allowable limit or less, corrosion of the optical element by the oxidation deterioration gas and oxidation coating formation are thought to be stopped. Therefore, the introduction of deterioration suppressing gas is continued until the oxidation deterioration gas has returned to an appropriate normal value at or below the above maximum limit.

Other techniques are also conceivable. In the case where the deterioration suppressing gas markedly drops from the partial pressure immediately following introduction, it is possible to consume the oxidation deterioration gas by means of the deterioration suppressing gas. Specifically, it is also possible to continue introduction of the deterioration suppressing gas until there is no longer a decrease in the partial pressure of the deterioration suppressing gas. It is possible to set the start of the introduction of the deterioration suppressing gas to an appropriate timing after the partial pressure of the oxidation deterioration gas has increased to at or above a previously set value, but at this time, it is also possible to set a status in which the light source apparatus 50 operates to irradiate extreme ultraviolet rays to the respective optical elements that comprise the illumination optical system 60 and the projection optical system 70. In this case, the extreme ultraviolet rays promote an oxidation reduction reaction and a fluorination reaction between the deterioration suppressing gas and the oxidation deterioration gas.

In an example of a reducing gas, when a ratio of the partial pressure of a deterioration suppressing gas, such as hydrogen or ethanol, to the partial pressure of an oxidation deterioration gas, such as oxygen or water, is in a range of 1×10⁻⁷ to 10×10⁴, consumption of the oxidation deterioration gas is observed. It is thus possible to avoid a decrease in the reflectivity of the optical elements 54, 55, 61, 62, 63, 64, 71, 72, 73, and 74. The reaction equation below explains consumption of the oxidation deterioration gas (oxygen, moisture) by ethanol, which is the deterioration suppressing gas.

(Oxygen/Moisture Reduction)
3O₂+C₂H₅OH→2CO₂+3H₂O
3H₂O+C₂H₅OH→2CO₂+6H₂

In addition, in an example of a fluorinating gas, when a ratio of the partial pressure of a deterioration suppressing gas, such as hydrogen fluoride, nitrogen fluoride, or carbon fluoride, to the partial pressure of an oxidation deterioration gas, such as oxygen or water, is in a range of 1×10⁻⁷ to 1×10⁴, surface oxidation film growth suppression is observed. It is thus possible to avoid a decrease in the reflectivity of optical elements 54, 55, 61, 62, 63, 64, 71, 72, 73, and 74. The reaction equation below explains decomposition of an oxidation film by hydrogen fluoride, nitrogen fluoride and carbon fluoride, which are the deterioration suppressing gases.

(Fluorination of Oxidation Film)
SiO₂+4HF→SiF₄+2H₂O
3SiO₂+4NF₃→3SiF₄+2N₂O₃
SiO₂+CF₄→SiF₄+CO₂

On the other hand, in the case where a coating forming gas such as an organic substance is present as the atmospheric gas of optical element 54, 55, 61, 62, 63, 64, 71, 72, 73, and 74 and extreme ultraviolet rays are incident to such an optical element, the organic substance decomposes due to the optical CVD phenomenon; a carbon film forms on the surface of the relevant optical element; and there is concern that the reflectivity will decrease over time. For this reason, the partial pressure of the coating forming gas is monitored based on the detection results of the mass spectrometry apparatus 87. When the partial pressure of the coating forming gas has exceeded a fixed upper limit, the mass flow controller 86e regulates the gas supply apparatus 86 to introduce an appropriate amount of deterioration suppressing gas (coating removing gas) to the vacuum container 84 from the gas sources 86a, 86b, and 86c.

The deterioration suppressing gas supplied from gas source 86a is a reducing gas, and, for example, hydrogen or ethanol is preferably used. The deterioration suppressing gas supplied from gas source 86b is an oxidizing gas, and, for example, ozone oxygen, nitrogen monoxide, or sulfur dioxide is preferably optimally used. The deterioration suppressing gas supplied from gas source 86c is a fluorinating gas, and, for example, hydrogen fluoride, nitrogen fluoride, or carbon fluoride is preferably used.

The amount of deterioration suppressing gas introduced into the vacuum container 84 is at a level that is able to offset the effects of the coating forming gas based on the partial pressure of the coating forming gas and the reduction capability, oxidation capability, etc. of the deterioration suppressing gas. For example, in the case where it is possible to return the partial pressure of the coating forming gas to the maximum allowable limit or less, carbon film formation on the surface of the optical element is thought to be stopped. Therefore, the introduction of deterioration suppressing gas is continued until the coating forming gas has returned to an appropriate normal level at or below the above maximum limit.

Other techniques are also conceivable. In the case where the deterioration suppressing gas had markedly dropped from the partial pressure immediately following introduction, it was possible to consume the coating forming gas and reduce carbon film by means of the deterioration suppressing gas. Specifically, it is also possible to continue introduction of deterioration suppressing gas until there is no longer a decrease in the partial pressure of the deterioration suppressing gas. It is possible to set the start of the introduction of the deterioration suppressing gas to an appropriate timing after the partial pressure of the coating forming gas has increased to at or above a previously set value, but, at this time, it is also possible to set a status in which the light source apparatus 50 operates to irradiate extreme ultraviolet rays to the respective optical elements that comprise the illumination optical system 60 and the projection optical system 70. In this case, the extreme ultraviolet rays promote an oxidation reduction reaction among the deterioration suppressing gas, organic substance, and the carbon film.

When the ratio of the partial pressure of a deterioration suppressing gas, which is a reducing gas or an oxidizing gas, to the partial pressure of the coating forming gas of the organic substance is in a range of 1×10⁻² to 1×10⁸, consumption of the coating forming gas is observed. It is thus possible to avoid a decrease in the reflectivity of optical elements 54, 55, 63, 61, 62, 64, 71, 72, 73, and 74. The reaction equation below explains consumption of the coating forming gas and removal of the carbon film by the deterioration suppressing gas.

(Oxidation of Hydrocarbons; by Oxygen, Ozone, Nitrogen Monoxide, and Sulfur Dioxide)
2CₙH₂ₙ₊₂+(3n+1)O₂→2nCO₂+(2n+2)H₂O
3CₙH₂ₙ₊₂+(3n+1)O₃→3nCO₂+(3n+3)H₂O
CₙH₂ₙ₊₂+2nNO→nCO₂+(n+1)H₂+nN₂
CₙH₂ₙ₊₂+nSO₂→nCO₂+nH₂S+H₂
(Reduction of Hydrocarbons; by Hydrogen)
CₙH₂ₙ₊₂+(n−1)H₂→nCH₄
(Fluorination of Hydrocarbons; by Hydrogen Fluoride and Nitrogen Fluoride)
CₙH₂ₙ₊₂+4nHF→nCF₄+(3n+1)H₂
3CₙH₂ₙ₊₂+4nNF₃→3nCF₄+2nN₂+(3n+3)H₂
(Oxidation of Carbon Film; by Oxygen, Ozone and Nitrogen Monoxide)
C+O₂→CO₂
3C+2O₃→3CO₂
C+2NO→CO₂+N₂
(Fluorination of Carbon Film; by Hydrogen Fluoride and Nitrogen Fluoride)
C+4HF→CF₄+2H₂
3C+4NF₃→3CF₄+2N₂

The luminous flux intensity sensor 88 is a photoelectric conversion element such as a photomultiplier. The sensor 88 advances into and retreats from the optical axis of the projection optical system 70. The sensor 88 measures the intensity of the exposure light by converting extreme ultraviolet rays, which are the exposure light that passes through the interior of the projection optical system 70 (specifically, reflected light from the mirror 74), into electrical signals. The sensor 88 operates under the control of the control apparatus 90 and outputs the detection results of the exposure light to the control apparatus 90 at an appropriate timing. The sensor 88 is not limited to one which directly detects reflected light from mirror 74, and it may also be one that detects scattered light from optical elements, such as mirror 74, that comprise the projection optical system 70. In this case, the mechanism for advancing the sensor 88 into and retreating the sensor 88 from the optical axis is not necessary, and an increase in detection strength indicates a decrease in the reflectivity of the image light of the optical elements, or a deterioration of the optical characteristics.

In the case where the coating forming gas and oxidizing gas are present as the atmospheric gas of optical element 54, 55, 61, 62, 63, 64, 71, 72, 73, and 74, carbon film and oxidation film form on the surface of the optical elements in the presence of extreme ultraviolet rays, and there is concern that reflectivity will decrease over time. For this reason, in the case where the luminous flux intensity of the exposure light is monitored based on the detection results of the luminous flux intensity sensor 88, and the luminous flux intensity has reached a fixed lower limit, the mass flow controller 86e regulates the gas supply apparatus 86 to introduce an appropriate amount of deterioration suppressing gas to the vacuum container 84 from the gas sources 86a, 86b and 86c. The amount of deterioration suppressing gas introduced into the vacuum container 84 is at a level such that the carbon film of the surfaces of the optical elements can be removed by oxidation reduction, or the oxidation film of the surfaces of the optical elements can be removed by fluorination.

Introduction of deterioration suppressing gas can be at an appropriate timing after the illumination intensity of the exposure light has been reduced to at or below a value that has been set in advance. It is also possible to set a status in which the light source apparatus 50 operates to irradiate extreme ultraviolet rays to the respective optical elements that comprise the illumination optical system 60 and the projection optical system 70. In this case, the extreme ultraviolet rays play the role of promoting an oxidation reduction reaction between the deterioration suppressing gas and the carbon film. In the case where, as a result of measurement by the luminous flux intensity sensor 88, the luminous flux intensity of the exposure light has returned to a previously set value or more, the control apparatus 90 operates the exhaust apparatus 85 to exhaust the deterioration suppressing gas in the vacuum container 84 to the exterior and stop the progress of the oxidation reduction reaction and the fluorination reaction.

When the ratio of the partial pressure of the deterioration suppressing gas, which is a reducing gas, an oxidizing gas, or a fluorinating gas, to the partial pressure of the coating forming gas of the organic substance is in a range of 1×10⁻²˜1×10⁸, it is possible to restore the reflectivity of optical elements 54, 55, 61, 62, 63, 64, 71, 72, 73, and 74.

The overall operation of the exposure apparatus shown in FIG. 1 will be explained below. A mask MA is illuminated by illumination light from an illumination optical system 60, and the pattern image of the mask MA is projected onto a wafer WA by means of the projection optical system 70. The pattern image of the mask MA is transferred onto the wafer WA. The mass spectrometry apparatus 87 monitors the partial pressure of the deterioration causing gas, which is an oxidizing gas or a coating forming gas. A deterioration suppressing gas is then appropriately introduced into the vacuum container 84 from the gas supply apparatus 86 under the control of the control apparatus 90, so it is possible to maintain good optical characteristics of the optical elements that comprise the projection optical system 70, etc. for a long period of time. In addition, the luminous flux intensity sensor 88 monitors decreases in the reflectivity of the optical elements that comprise the projection optical system 70. A deterioration suppressing gas from the gas supply apparatus 86 is then appropriately introduced into the vacuum container 84 under the control of the control apparatus 90. Through this as well, it is possible to maintain good optical characteristics of the optical elements that comprise the projection optical system 70 for a long period of time.

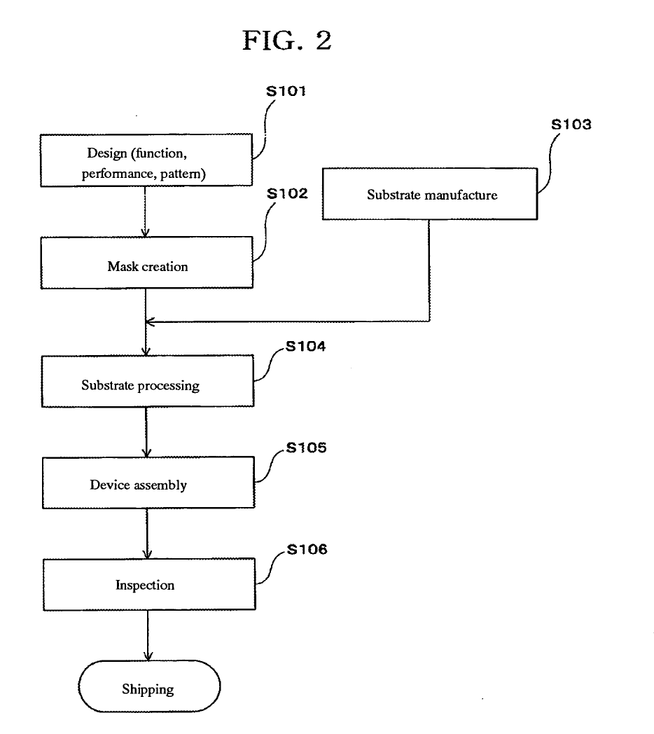

In the above, the explanation was for an exposure apparatus 10 and an exposure method using the apparatus 10. It is possible to provide a device manufacturing method for manufacturing semiconductor devices and other microdevices with high integration by using the exposure apparatus 10. Specifically, as shown in FIG. 2, microdevices are manufactured by going through a process that includes designing microdevice functions and performance (S101), manufacturing a mask MA based on this design (S102), preparing a substrate, that is, a wafer WA, which is the base material of the device (S103), exposing a pattern of the mask MA on the wafer WA using the exposure apparatus 10 of the embodiment discussed above (S104), completing the element while repeating a series of exposures, etchings, etc. (S105), and inspecting the device following assembly (S106). A dicing process, a bonding process, a packaging process, etc. are normally included in the device assembly process (S105).

The present invention was explained according to the above embodiments, but the present invention is not limited to the above embodiments. For example, in the above embodiments, an explanation was given with respect to an exposure apparatus that uses extreme ultraviolet rays as the exposure light, but it is also possible to incorporate the gas supply apparatus 86, mass spectrometry apparatus 87, and luminous flux intensity sensor 88 discussed above in an exposure apparatus that uses ultraviolet rays as the exposure light. In this case as well, it is possible to effectively prevent deterioration of optical characteristics including decreases in reflectivity and decreases in transmission rate resulting from oxidation and carbon deposition in relation to reflection type or transmission type optical elements that comprise the exposure apparatus by controlling the operation of the gas supply apparatus 86, the mass spectrometry apparatus 87, and the luminous flux intensity sensor 88 by means of the control apparatus 90.

In addition, in the above embodiments, the corresponding deterioration suppressing gas is introduced into the vacuum container 84 by individually determining the monitoring results of the oxidation deterioration gas, the monitoring results of the coating forming gas, or the monitoring results of the luminous flux intensity of the exposure light, but it is also possible to total the monitoring results of the oxidation deterioration gas, the monitoring results of the coating forming gas, and the monitoring results of the luminous flux intensity of the exposure light to determine which of the reducing gas or oxidizing gas to introduce into the vacuum container 84 and to introduce these gases into the vacuum container 84 until effects become apparent.

In addition, it is possible to form a reflecting film, etc. consisting of a single layer metal film, etc. in place of a multilayer film in optical elements 54, 55, 61, 62, 63, 64, 71, 72, 73, and 74 and in the mask MA.

In addition, in the above embodiments, an apparatus that uses extreme ultraviolet rays as the exposure light was explained, but it is also possible to incorporate optical elements 54, 55, 61, 62, 63, 64, 71, 72, 73, and 74 and a mask MA, such as those shown in FIG. 1, etc., into a projection exposure apparatus that uses ultraviolet rays other than extreme ultraviolet rays as the exposure light, and it is possible to control deterioration of the reflection characteristics of the optical elements resulting from carbon deposition, etc. by means of the same type of atmospheric control as the above.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims

What is claimed is:

1. An exposure apparatus control method, comprising:
monitoring an observation element that reflects one of causes and indications of deterioration of an optical system of an exposure apparatus, and
introducing a deterioration suppressing gas that includes at least one of a reducing gas, an oxidizing gas, and a fluorinating gas according to the monitoring results.

2. An exposure apparatus control method according to claim 1, wherein the observation element includes the partial pressure of a deterioration causing gas that includes at least one of oxygen, water, and an organic substance, and
the deterioration suppressing gas is introduced into a container according to the monitoring results of the deterioration causing gas so that the ratio of the partial pressure of the deterioration suppressing gas to the partial pressure of the deterioration causing gas is in a prescribed range.

3. An exposure apparatus control method according to claim 2, wherein the deterioration causing gas is an oxidation deterioration gas that includes at least one of oxygen and water, and the deterioration suppressing gas is an oxidation inhibiting gas that includes at least one of a reducing gas and a fluorinating gas.

4. An exposure apparatus control method according to claim 3, wherein the ratio is from 1×10⁻⁷ to 1×10⁴.

5. An exposure apparatus control method according to claim 2, wherein the deterioration causing gas is a coating forming gas that includes an organic substance, and the deterioration suppressing gas is a coating removing gas that includes at least one of a reducing gas, an oxidizing gas, and a fluorinating gas.

6. An exposure apparatus control method according to claim 5, wherein the ratio is from 1×10⁻² to 1×10⁸.

7. An exposure apparatus control method according to claim 1, wherein
the observation element includes the spectral characteristics of at least one optical element that comprises the optical system of an exposure apparatus, and
the deterioration suppressing gas is introduced into a container that accommodates the at least one optical element according to the monitoring results of the spectral characteristics of the at least one optical element.

8. An exposure apparatus control method according to claim 1, wherein the optical system is used in at least one wavelength range from among ultraviolet rays and extreme ultraviolet rays.

9. An exposure method for forming a mask pattern image on a substrate, comprising:
monitoring an observation element that reflects at least one of causes and indications of deterioration of an optical system for exposure, and
introducing a deterioration suppressing gas that includes at least one of a reducing gas, an oxidizing gas, and a fluorinating gas according to the monitoring results.

10. An exposure method according to claim 9, wherein
the observation element includes the partial pressure of a deterioration causing gas that includes at least one of oxygen, water, and an organic substance in a container that accommodates the optical system, and
the deterioration suppressing gas is introduced into the container according to the monitoring results of the deterioration causing gas so that the ratio of the partial pressure of the deterioration suppressing gas to the partial pressure of the deterioration causing gas is in a prescribed range in the container.

11. An exposure method according to claim 9, wherein
the observation element includes the spectral characteristics of at least one optical element that comprises the optical system, and
the deterioration suppressing gas is introduced into a container that accommodates at least one optical element according to the monitoring results of the spectral characteristics of the at least one optical element.

12. An exposure apparatus, comprising:
a light source configured to generate light in a wavelength range of at least one of ultraviolet rays and extreme ultraviolet rays,
an illumination optical system configured to guide the light from the light source to a mask,
a projection optical system configured to form a pattern image of the mask on a substrate,
a sensor configured to monitor an observation element that reflects at least one of causes and indications of deterioration of the projection optical system,
a gas introduction apparatus configured to introduce a deterioration suppressing gas that includes at least one of a reducing gas, an oxidizing gas, and a fluorinating gas according to the monitoring results, and
a control apparatus configured to control the operation of the gas introduction apparatus according to the monitoring results.

13. An exposure apparatus, comprising:
a light source configured to generate light in a wavelength range of at least one of ultraviolet rays and extreme ultraviolet rays,
an illumination optical system configured to guide the light from the light source to a mask for transfer,
a projection optical system configured to form a pattern image of the mask on a substrate,
a sensor configured to monitor the partial pressure of a deterioration causing gas that includes at least one of oxygen, water, and an organic substance in a container that accommodates at least some optical elements from among the illumination optical system and projection optical system,
a gas introduction apparatus configured to introduce a deterioration suppressing gas that includes at least one of a reducing gas, an oxidizing gas, and a fluorinating gas into the container, and
a control apparatus configured to set a ratio of the partial pressure of the deterioration suppressing gas to the partial pressure of the deterioration causing gas to a prescribed range by controlling the operation of the gas introduction apparatus according to the monitoring results of the deterioration causing gas.

14. An exposure apparatus according to claim 13, wherein the deterioration causing gas is an oxidation deterioration gas that includes at least one of oxygen and water, and
the deterioration suppressing gas is an oxidation inhibiting gas that includes at least one of a reducing gas and a fluorinating gas.

15. An exposure apparatus according to claim 13, wherein the deterioration causing gas is a coating forming gas that includes an organic substance, and the deterioration suppressing gas is a coating removing gas that includes at least one of a reducing gas, an oxidizing gas, and a fluorinating gas.

16. An exposure apparatus, comprising:
a light source configured to generate light in a wavelength range of at least one of ultraviolet rays and extreme ultraviolet rays,
an illumination optical system configured to guide the light from the light source to a mask,
a projection optical system configured to form a pattern image of the mask on a substrate,
a sensor configured to monitor the spectral characteristics of at least one optical element from among the illumination optical system and projection optical system,
a gas introduction apparatus introduce a deterioration suppressing gas that includes at least one of a reducing gas, an oxidizing gas, and a fluorinating gas, and
a control apparatus configured to control the operation of the gas introduction apparatus according to the monitoring results of the spectral characteristics of the at least one optical element.

17. A device manufacturing method that uses an exposure apparatus according to claim 12.

18. A device manufacturing method that uses an exposure apparatus according to claim 13.

19. A device manufacturing method that uses an exposure apparatus according to claim 16.
